(19) United States
(12) Patent Application Publication
(10) Pub. No.: US 2021/0230382 A1
(43) Pub. Date: Jul. 29, 2021

(54) Thermoplastic Resin Film, Meltable Bag, and Packaged Hot-Melt Adhesive

(71) Applicant: Sekisui Fuller Company, Ltd., Tokyo (JP)

(72) Inventors: Tadashi Muramoto, Hamamatsu-shi, Shizuoka (JP); Yu Someya, Hamamatsu-shi, Shizuoka (JP); Rikio Genma, Hamamatsu-shi, Shizuoka (JP); Kazuya Suzuki, Hamamatsu-shi, Shizuoka (JP)

(21) Appl. No.: 15/734,985

(22) PCT Filed: Jun. 3, 2019
(86) PCT No.: PCT/JP2019/021899

§ 371 Date: Dec. 3, 2020

(30) Foreign Application Priority Data
Jun. 4, 2018 (JP) 2018-107077

(51) Int. Cl. C08J 5/18; C08L 23/08; B29C 48/00; B29C 48/08; B29C 65/02; B65B 9/02

(52) U.S. Cl. CPC C08J 5/18; C08L 23/0815; B29C 48/022; B29C 48/08; B29C 65/02; B29L 2031/7128; C08J 2323/06; C08J 2323/08; C08J 2423/08; B29K 2023/06; B65B 9/023

(57) ABSTRACT

There are provided a thermoplastic resin film suitable for forming a meltable bag for packaging a hot-melt adhesive, the thermoplastic resin film having a high melting rate and high bag breakage resistance because adhesion between thermoplastic resin films is suppressed when packaged hot-melt adhesives are stored in a stacked manner and thus the breakage of the meltable bags is suppressed when the meltable bags are peeled apart, a meltable bag formed of the thermoplastic resin film, and a packaged hot-melt adhesive. A thermoplastic resin film contains at least one resin selected from the group consisting of a polyethylene resin and an ethylene-based copolymer, wherein (1) the film has at least one embossed surface, and the at least one embossed surface has a ten point height of irregularities Rzjis of 10 to 200 μm, (2) the film has a melting point of 60° C. to 120° C., and (3) an elastic modulus in a TD direction and an elastic modulus in an MD direction are both 15 MPa or more.

### TECHNICAL FIELD

The present invention relates to a thermoplastic resin film, a meltable bag, and a packaged hot-melt adhesive.

### BACKGROUND ART

In the related art, so-called meltable bags that can be melted by directly charging a packaged hot-melt adhesive obtained by packaging a hot-melt adhesive with a bag into a high-temperature container without stripping the bag have been used as bags for packaging hot-melt adhesives.

For example, a meltable bag formed of a low-density polyethylene resin having a melting point, a density, and a melt flow rate in particular ranges has been proposed as a meltable bag formed of such a thermoplastic resin film (refer to PTL 1).

### CITATION LIST

### Patent Literature

[PTL 1] Japanese Unexamined Patent Application Publication No. 2014-177284

### SUMMARY OF INVENTION

### Technical Problem

The thermoplastic resin film for forming the meltable bag is required to have a high melting rate. At a low melting rate, molten residues are generated when a packaged hot-melt adhesive is melted.

The packaged hot-melt adhesive is sometimes stored and transported in a stacked manner, and is also sometimes charged into a high-temperature container after placed in a stacked manner. The stacking of packaged hot-melt adhesives causes adhesion between the packaged hot-melt adhesives because of blocking between thermoplastic resin films that constitute meltable bags, which poses a problem in that meltable bags are broken when peeled apart.

In view of the foregoing, it is an object of the present invention to provide a thermoplastic resin film suitable for forming a meltable bag for packaging a hot-melt adhesive, the thermoplastic resin film having a high melting rate and high bag breakage resistance because adhesion between thermoplastic resin films is suppressed when packaged hot-melt adhesives are stored in a stacked manner and thus the breakage of the meltable bags is suppressed when the meltable bags are peeled apart, a meltable bag formed of the thermoplastic resin film, and a packaged hot-melt adhesive.

### Solution to Problem

As a result of thorough studies conducted to achieve the above object, the present inventors have found that the above object can be achieved by using a thermoplastic resin film which contains at least one resin selected from the group consisting of a polyethylene resin and an ethylene-based copolymer and in which the ten point height of irregularities Rzjis of an embossed surface, the melting point, and the elastic modulus in a TD direction and the elastic modulus in an MD direction are within particular ranges. Thus, they have completed the present invention.

That is, the present invention relates to a thermoplastic resin film, a meltable bag, and a packaged hot-melt adhesive below.

1. A thermoplastic resin film containing at least one resin selected from the group consisting of a polyethylene resin and an ethylene-based copolymer, wherein

(1) the film has at least one embossed surface, and the at least one embossed surface has a ten point height of irregularities Rzjis of 10 to 200 μm,

(2) the film has a melting point of 60° C. to 120° C., and

(3) an elastic modulus in a TD direction and an elastic modulus in an MD direction are both 15 MPa or more.

2. The thermoplastic resin film according to 1, wherein the ethylene-based copolymer includes ethylene-vinyl ester copolymers and/or ethylene-(meth)acrylic acid ester copolymers.

3. The thermoplastic resin film according to 1, wherein the film has a melting point of 70 to 120° C., and the ethylene-based copolymer is an ethylene-vinyl acetate copolymer.

4. The thermoplastic resin film according to 1, wherein the ethylene-based copolymer is at least one member selected from the group consisting of ethylene-vinyl acetate copolymers, ethylene-methyl acrylate copolymers, ethylene-methyl methacrylate copolymers, ethylene-ethyl acrylate copolymers, ethylene-butyl acrylate copolymers, ethylene-octyl acrylate copolymers, ethylene-2-ethylhexyl acrylate copolymers, ethylene-ethyl methacrylate copolymers, ethylene-butyl methacrylate copolymers, ethylene-octyl methacrylate copolymers, and ethylene-2-ethylhexyl methacrylate copolymers.

5. The thermoplastic resin film according to any one of 1 to 4, wherein the at least one embossed surface has an arithmetic mean peak curvature Spc of less than 4000 mm⁻¹ as measured in conformity with ISO 25178.

6. The thermoplastic resin film according to any one of 1 to 5, which is used for packaging a hot-melt adhesive.

7. A meltable bag including the thermoplastic resin film according to any one of 1 to 6.

8. A packaged hot-melt adhesive including the meltable bag according to 7 and a hot-melt adhesive packaged with the meltable bag.

### Advantageous Effects of Invention

The thermoplastic resin film according to the present invention can be suitably used as a thermoplastic resin film that constitutes a meltable bag for packaging a hot-melt adhesive because the film has a high melting rate and high bag breakage resistance. The high bag breakage resistance is achieved because adhesion between thermoplastic resin films is suppressed when packaged hot-melt adhesives are stored in a stacked manner and thus the breakage of meltable bags is suppressed when the meltable bags are peeled apart. The meltable bag according to the present invention is formed of the thermoplastic resin film and the packaged hot-melt adhesive according to the present invention includes the meltable bag and a hot-melt adhesive packaged with the meltable bag. Therefore, a high melting rate and high bag breakage resistance are achieved.

### DESCRIPTION OF EMBODIMENTS

A thermoplastic resin film according to the present invention is a thermoplastic resin film containing at least one resin selected from the group consisting of a polyethylene resin and an ethylene-based copolymer.

(1) The film has at least one embossed surface, and the at least one embossed surface has a ten point height of irregularities Rzjis of 10 to 200 μm. (2) The film has a melting point of 60° C. to 120° C. (3) The elastic modulus in a TD direction and the elastic modulus in an MD direction are both 15 MPa or more.

A thermoplastic resin film according to the present invention contains the above resin, and (1) the film has at least one embossed surface and the at least one embossed surface has a ten point height of irregularities Rzjis of 10 to 200 μm, and (3) the elastic modulus in a TD direction and the elastic modulus in an MD direction are both 15 MPa or more. Therefore, a meltable bag having good anti-blocking properties and high bag breakage resistance can be formed when a packaged hot-melt adhesive is provided. Furthermore, a thermoplastic resin film according to the present invention contains the above resin, and (1) the film has at least one embossed surface with a particular pattern and thus melting is easily caused from a thin portion and (2) the film has a melting point of 60° C. to 120° C. Therefore, a high melting rate is achieved. In other words, the thermoplastic resin film according to the present invention contains the above resin and has the features (1) to (3) in a combined manner, and thus a high melting rate and high bag breakage resistance are achieved. The high bag breakage resistance is achieved because adhesion between thermoplastic resin films is suppressed when packaged hot-melt adhesives are stored in a stacked manner and thus the breakage of meltable bags is suppressed when the meltable bags are peeled apart. Therefore, the thermoplastic resin film can be suitably used to form a meltable bag for packaging a hot-melt adhesive.

Hereafter, the thermoplastic resin film, the meltable bag, and the packaged hot-melt adhesive according to the present invention will be described in detail.

1. Thermoplastic Resin Film

The thermoplastic resin film according to the present invention contains at least one resin selected from the group consisting of a polyethylene resin and an ethylene-based copolymer.

The polyethylene resin is not particularly limited, and publicly known polyethylene resins for meltable bags can be widely used. Examples of the polyethylene resin include low-density polyethylene resins, linear low-density polyethylene resins, middle-density polyethylene resins, and high-density polyethylene resins. Among them, low-density polyethylene resins are preferred.

The low-density polyethylene resins are preferably low-density polyethylene resins produced by polymerizing ethylene at high pressure using a radical polymerization catalyst.

The melting point of the polyethylene resin is preferably 115° C. or lower and more preferably 110° C. or lower. When the melting point is within the above ranges, meltable bags are more easily melted even at a low temperature of, for example, about 150° C., which further suppresses generation of residues. The lower limit of the melting point of the polyethylene resin is not particularly limited, and is about 100° C.

In this specification, the melting point of resins is measured by a method conforming to JIS K7121 using a differential scanning calorimeter (DSC). That is, the temperature is increased from room temperature to 150° C. at a rate of 10° C./min, decreased to 0° C. at a rate of 10° C./min, and then increased to 150° C. at a rate of 10° C./min. The melting point is determined from an endothermic peak observed during the second increase in temperature.

The density of the polyethylene resin is preferably 0.910 to 0.930 g/cm³ and more preferably 0.915 to 0.920 g/cm³. When the lower limit of the density of the polyethylene resin is within the above ranges, blocking between thermoplastic resin films that constitute meltable bags is further suppressed. When the upper limit of the density of the polyethylene resin is within the above ranges, generation of residues is further suppressed, which further improves the melting rate.

In this specification, the density of resins and the density of thermoplastic resin films described later are measured by a method conforming to JIS K6760.

The melt flow rate (MFR) of the polyethylene resin is preferably 10 to 35 g/10 min and more preferably 15 to 25 g/10 min. When the lower limit of the melt flow rate of the polyethylene resin is within the above ranges, generation of residues is further suppressed, which further improves the meltability. When the upper limit of the melt flow rate of the polyethylene resin is within the above ranges, the bag breakage resistance is further improved.

In this specification, the MFR of resins and the MFR of thermoplastic resin films described later are measured in conformity with ASTM D1238 at a temperature of 190° C. under a load of 2.16 kg.

Commercially available polyethylene resins can be used. Examples of the commercially available polyethylene resins include “Novatec LJ802” (trade name) manufactured by Japan Polyethylene Corporation, “Suntec M6520” (trade name) manufactured by Asahi Kasei Chemicals Corporation, and “Petrothene 202” (trade name) manufactured by Tosoh Corporation.

These polyethylene resins may be used singly or in a combination or two or more.

The ethylene-based copolymer is obtained from ethylene and a comonomer containing an unsaturated vinyl group. The ethylene-based copolymer preferably contains an ethylene-vinyl ester copolymer and/or an ethylene-(meth)acrylic-acid ester copolymer.

The ethylene-based copolymer includes ethylene-vinyl acetate copolymers (EVA), ethylene-methyl acrylate copolymers (EMA), ethylene-methyl methacrylate copolymers (EMMA), ethylene-ethyl acrylate copolymers (EEA), ethylene-butyl acrylate copolymers (EBA), ethylene-octyl acrylate copolymers, ethylene-2-ethylhexyl acrylate copolymers, ethylene-ethyl methacrylate copolymers, ethylene-butyl methacrylate copolymers, ethylene-octyl methacrylate copolymers, and ethylene-2-ethylhexyl-methacrylate copolymers. Of these, ethylene-vinyl acetate copolymers (EVA), ethylene-methyl acrylate copolymers (EMA), ethylene-ethyl acrylate copolymers (EEA), ethylene-butyl acrylate copolymers (EBA), and ethylene-methyl methacrylate copolymers (EMMA) are preferable; and ethylene-vinyl acetate copolymers (EVA), ethylene-ethyl acrylate copolymers (EEA), and ethylene-methyl acrylate copolymers (EMMA) are more preferable.

These ethylene-based copolymers may be used singly or in a combination of two or more.

The density of the ethylene-based copolymer is preferably 0.900 to 0.980 g/cm³, and more preferably 0.910 to 0.970 g/cm³. When the lower limit of the density of ethylene-based copolymer is within the above ranges, blocking of the thermoplastic resin films that constitute meltable bags is further suppressed. When the upper limit of the density of the ethylene-based copolymer is within the above ranges, generation of residues is further suppressed, which further improves the melting rate.

In this specification, the density of resins and the density of the thermoplastic resin films described later are measured by a method conforming to JIS K6760.

The MFR of the ethylene-based copolymer is preferably 2 to 35 g/10 min, and more preferably 6 to 30 g/10 min. When the lower limit of the melt flow rate of the ethylene-based copolymer is within the above ranges, generation of residues is further suppressed, which further improves the meltability. When the upper limit of the melt flow rate of the ethylene-based copolymer is within the above ranges, breakage resistance is further improved.

In this specification, the MFR of resins is measured at a temperature of 190° C. under a load of 2.16 kg in accordance with ASTM D1238.

The ethylene-based copolymer for use may be commercially available ethylene-based copolymers. Examples of commercially available ethylene-based copolymers include “V406” (product name) manufactured by Du Pont-Mitsui Chemicals, “EB440H” (product name) manufactured by Japan Polyethylene Corporation, “DPDJ-9169” (product name) manufactured by Nippon Unicar Company Limited, “A6200” (product name) manufactured by Japan Polyethylene Corporation, “17BA07N” (product name) manufactured byLotryl, and “AcryftWH401-F” (product name) manufactured by Sumitomo Chemical Co., Ltd. Examples of EMMA include “Acryft” manufactured by Sumitomo Chemical Co., Ltd; examples of EEA include EEA manufactured by Nippon Unicar Company Limited and “Rexpearl EEA” manufactured by Japan Polyethylene Corporation; examples of EMA include “Rexpearl EMA” manufactured by Japan Polyethylene Corporation; and examples of EBA include “Lotryl” manufactured by Lotryl.

The ethylene-vinyl acetate copolymer is not particularly limited, and publicly known ethylene-vinyl acetate copolymers for meltable bags can be widely used.

The ethylene-vinyl acetate copolymer is not particularly limited as long as the copolymer is obtained by copolymerizing ethylene and vinyl acetate. In addition to ethylene and vinyl acetate, other polymerizable monomers may be contained.

The ethylene-vinyl acetate copolymer may be a copolymer resin with a low vinyl acetate content obtained by a solution polymerization method or a copolymer resin with a high vinyl acetate content obtained by an emulsion method. The vinyl acetate content (VA content) in the ethylene-vinyl acetate copolymer is preferably 3 to 25 mass % and more preferably 5 to 20 mass %. When the vinyl acetate content in the ethylene-vinyl acetate copolymer is within the above ranges, the thermoplastic resin film according to the present invention has better low-temperature meltability and generation of residues is further suppressed.

The melting point of the ethylene-vinyl acetate copolymer is preferably 110° C. or lower and more preferably 105° C. or lower. When the melting point is within the above ranges, meltable bags are more easily melted even at a low temperature of, for example, about 150° C., which further suppresses generation of residues. The lower limit of the melting point of the ethylene-vinyl acetate copolymer is not particularly limited, and is about 60° C.

The density of the ethylene-vinyl acetate copolymer is preferably 0.920 to 0.950 g/cm³ and more preferably 0.925 to 0.945 g/cm³. When the lower limit of the density of the ethylene-vinyl acetate copolymer is within the above ranges, generation of residues is further suppressed, which further improves the meltability. When the upper limit of the density of the ethylene-vinyl acetate copolymer is within the above ranges, blocking between thermoplastic resin films that constitute meltable bags is further suppressed.

The melt flow rate of the ethylene-vinyl acetate copolymer is preferably 10 to 35 g/10 min and more preferably 15 to 25 g/10 min. When the lower limit of the melt flow rate of the ethylene-vinyl acetate copolymer is within the above ranges, generation of residues is further suppressed, which further improves the meltability. When the upper limit of the melt flow rate of the ethylene-vinyl acetate copolymer is within the above ranges, the bag breakage resistance is further improved.

Commercially available ethylene-vinyl acetate copolymers can be used. An example of the commercially available ethylene-vinyl acetate copolymers is “V406” (trade name) manufactured by Dupont-Mitsui Polychemicals Co., Ltd.

In the thermoplastic resin film according to the present invention, the polyethylene resin and the ethylene-based copolymer may be used alone or in combination. When the total content of the polyethylene resin and the ethylene-based copolymer used in combination in the thermoplastic resin film is assumed to be 100 mass %, the polyethylene resin content is preferably 1 to 50 mass %, more preferably 5 to 40 mass %, and further preferably 10 to 30 mass %.

When the thermoplastic resin film contains the ethylene-vinyl acetate copolymer, the vinyl acetate content in the thermoplastic resin film is preferably 0.1 to 35 mass % and more preferably 1 to 30 mass %.

The thermoplastic resin film according to the present invention may contain additives such as a slipping agent, a light stabilizer, and an ultraviolet absorber as long as the characteristics are not considerably impaired.

The slipping agent is not particularly limited, and publicly known slipping agents can be used. An example of the slipping agent is erucamide.

The upper limit of the content of the slipping agent in the thermoplastic resin film is preferably 3,000 ppm and more preferably 2,000 ppm. When the content of the slipping agent is within the above ranges, the thermoplastic resin film according to the present invention can exhibit better anti-blocking properties and generation of residues is further suppressed, which further improves the melting rate. The lower limit of the content of the slipping agent is not particularly limited, and is preferably 0 ppm.

The thermoplastic film according to the present invention has at least one embossed surface. It is sufficient that at least one surface of the thermoplastic resin film is embossed, but both surfaces may be embossed.

The embossed pattern is not particularly limited, and may be a regular embossed pattern or an irregular embossed pattern. The embossed pattern is not particularly limited, and may be, for example, a lattice pattern, a crepe pattern, a diamond pattern, a pyramid pattern, a hexagonal pattern, a circular pattern, or a striped pattern.

The ten point height of irregularities Rzjis of the embossed surface of the thermoplastic resin film is 10 to 200 μm. If the ten point height of irregularities Rzjis is less than 10 μm, sufficient anti-blocking properties of the thermoplastic resin film are not achieved. If the ten point height of irregularities Rzjis is more than 200 μm, sufficient internal visibility of the thermoplastic resin film is not achieved. The ten point height of irregularities Rzjis is preferably 15 to 150 μm.

In this specification, the ten point height of irregularities Rzjis is measured by a method conforming to JIS B0601:2001. In the thermoplastic resin film according to the present invention, the ten point height of irregularities Rzjis is measured on a surface which is embossed and at which protrusions of the embossed pattern are formed.

The thermoplastic resin film according to the present invention has a melting point of 60° C. to 120° C. If the melting point is lower than 60° C., the bag breakage resistance decreases. If the melting point is higher than 120° C., molten residues are generated, which decreases the melting rate. The melting point is preferably 70° C. to 120° C. and more preferably 75° C. to 120° C.

In this specification, the melting point of thermoplastic resin films is measured using a differential scanning calorimeter (DSC) by a method conforming to JIS K7121. That is, the temperature is increased from room temperature to 150° C. at a rate of 10° C./min, decreased to 0° C. at a rate of 10° C./min, and then increased to 150° C. at a rate of 10° C./min. The melting point is determined from an endothermic peak observed during the second increase in temperature.

The thermoplastic resin film according to the present invention preferably has a melting point of 70 to 120° C., and the ethylene-based copolymer contained in the thermoplastic resin film is preferably an ethylene-vinyl acetate copolymer.

In the thermoplastic resin film according to the present invention, the elastic modulus in a TD direction and the elastic modulus in an MD direction are both 15 MPa or more. If the elastic modulus is less than 15 MPa, the peel strength increases because of adhesion between thermoplastic resin films, which degrades the bag breakage resistance. The elastic modulus in a TD direction and the elastic modulus in an MD direction are both preferably 20 Pa or more and more preferably 40 MPa or more. The upper limit of each of the elastic modulus in a TD direction and the elastic modulus in an MD direction is preferably 120 MPa or less and more preferably 100 MPa or less. When the upper limit of the elastic modulus is within the above ranges, the flexibility of the thermoplastic resin film is further improved.

In this specification, the elastic modulus is measured by the following method. That is, the thermoplastic resin film is cut into strip specimens having a width of 20 mm and a length of 100 mm. The end portion of the specimen in a long-side direction (the side in a short-side direction) is fixed to a tensile tester, and a tensile test is performed at a tension rate of 50 mm/min to measure the elastic modulus. In the case where the elastic modulus of the thermoplastic resin film in an MD direction is measured, the specimen is prepared so that the long-side direction of the specimen corresponds to an MD direction. In the case where the elastic modulus in a TD direction is measured, the specimen is prepared so that the long-side direction of the specimen corresponds to a TD direction.

For the thermoplastic resin film according to the present invention, the arithmetic mean peak curvature Spc, which is measured in conformity with ISO 25178, of the embossed surface is preferably less than 4000 mm⁻¹, more preferably 2500 mm⁻¹ or less, further preferably 1000 mm⁻¹ or less, and most preferably 500 mm⁻¹ or less. When the upper limit of the arithmetic mean peak curvature Spc is within the above ranges, irregular reflection of light is suppressed and the light is more easily transmitted, which further improves the internal visibility of the thermoplastic resin film. The arithmetic mean peak curvature Spc is preferably 100 mm⁻¹ or more, more preferably 200 mm⁻¹ or more, and further preferably 250 mm⁻¹ or more. When the lower limit of the arithmetic mean peak curvature Spc is within the above ranges, the bag breakage resistance of the thermoplastic resin film is further improved.

In this specification, the arithmetic mean peak curvature Spc is measured at a magnification of 1000 times by a method conforming to ISO 25178. For example, the arithmetic mean peak curvature Spc can be determined by capturing and analyzing a film surface with a 3D laser scanning confocal microscope (VK-X1000) manufactured by KEYENCE Corporation. When the measurement is performed at a magnification of about 100 times, it is difficult to measure an arithmetic mean peak curvature Spc of less than 4000 mm⁻¹, which makes it difficult to confirm the further improvement in the internal visibility of the thermoplastic resin film.

For the thermoplastic resin film according to the present invention, the arithmetic mean height Sa, which is measured in conformity with ISO 25178, of the embossed surface is preferably 1.3 μm or less, more preferably 1.0 μm or less, and further preferably 0.5 μm or less. When the upper limit of the arithmetic mean height Sa is within the above ranges, the internal visibility of the thermoplastic resin film is further improved. The arithmetic mean height Sa is preferably 0.0007 μm or more, more preferably 0.0010 μm or more, and further preferably 0.0015 μm or more. When the lower limit of the arithmetic mean height Sa is within the above ranges, the bag breakage resistance of the thermoplastic resin film is further improved.

In this specification, the arithmetic mean height Sa is measured at a magnification of 1000 times by a method conforming to ISO 25178. For example, the arithmetic mean height Sa can be determined by capturing and analyzing a film surface with a 3D laser scanning confocal microscope (VK-X1000) manufactured by KEYENCE Corporation.

For the thermoplastic resin film according to the present invention, the developed interfacial area ratio Sdr, which is measured in conformity with ISO 25178, of the embossed surface is preferably 0.30 or less, more preferably 0.25 or less, and further preferably 0.10 or less. When the upper limit of the developed interfacial area ratio Sdr is within the above ranges, the internal visibility of the thermoplastic resin film is further improved. The developed interfacial area ratio Sdr is preferably 0.0005 or more, more preferably 0.0010 or more, and further preferably 0.0015 or more. When the lower limit of the developed interfacial area ratio Sdr is within the above ranges, the bag breakage resistance of the thermoplastic resin film is further improved.

In this specification, the developed interfacial area ratio Sdr is measured at a magnification of 1000 times by a method conforming to ISO 25178. For example, the developed interfacial area ratio Sdr can be determined by capturing and analyzing a film surface with a 3D laser scanning confocal microscope (VK-X1000) manufactured by KEYENCE Corporation.

For the thermoplastic resin film according to the present invention, the maximum height Sz, which is measured in conformity with ISO 25178, of the embossed surface is preferably 20 μm or less, more preferably 10 μm or less, and further preferably 5 μm or less. When the upper limit of the maximum height Sz is within the above ranges, the internal visibility of the thermoplastic resin film is further improved. The maximum height Sz is preferably 0.6 μm or more, more preferably 1.0 μm or more, and further preferably 2.0 μm or more. When the lower limit of the maximum height Sz is within the above ranges, the bag breakage resistance of the thermoplastic resin film is further improved.

In this specification, the maximum height Sz is measured at a magnification of 1000 times by a method conforming to ISO 25178. For example, the maximum height Sz can be determined by capturing and analyzing a film surface with a 3D laser scanning confocal microscope (VK-X1000) manufactured by KEYENCE Corporation.

The haze of the thermoplastic resin film is preferably 90% or less and more preferably 80% or less. When the upper limit of the haze of the thermoplastic resin film is within the above ranges, the internal visibility of the thermoplastic resin film is further improved. The lower limit of the haze of the thermoplastic resin film is not particularly limited, and is about 1%.

In this specification, the haze of the thermoplastic resin film is measured by a method conforming to JIS K7105 using a haze meter. In the thermoplastic resin film according to the present invention, the haze is measured from a surface which is embossed and at which protrusions of the embossed pattern are formed.

The coefficient of friction of the thermoplastic resin film is preferably 0.7 or less and more preferably 0.6 or less. When the upper limit of the coefficient of friction of the thermoplastic resin film is within the above ranges, the anti-blocking properties of the thermoplastic resin film are further improved, which further improves the bag breakage resistance. The lower limit of the coefficient of friction of the thermoplastic resin film is not particularly limited, and is about 0.05.

The density of the thermoplastic resin film is preferably 0.910 to 0.950 g/cm³ and more preferably 0.920 to 0.945 g/cm³. When the lower limit of the density of the thermoplastic resin film is within the above ranges, blocking between thermoplastic resin films that constitute meltable bags is further suppressed, which further improves the bag breakage resistance. When the upper limit of the density of the thermoplastic resin film is within the above ranges, generation of residues is further suppressed, which further improves the melting rate.

The layer structure of the thermoplastic resin film is not particularly limited. The thermoplastic resin film may have a single-layer structure or a multilayer structure.

When the layer structure of the thermoplastic resin film is a multilayer structure, the number of layers is not particularly limited (e.g., 2, 3, or 4 layers), and is preferably 2 to 7 layers, and more preferably 2 to 5 layers.

When the layer structure of the thermoplastic resin film is a multilayer structure, it is sufficient if at least one surface of the thermoplastic resin film formed of multiple laminated layers is embossed. When such a thermoplastic resin film is used for packaging a hot-melt adhesive, the embossed pattern is preferably formed on the surface opposite the surface that comes in contact with the hot-melt adhesive. When the layer structure of the thermoplastic resin film is a multilayer structure, it is sufficient if the at least one embossed surface has a ten point height of irregularities Rzjis of 10 to 200 μm.

When the layer structure of the thermoplastic resin film is a multilayer structure, the melting point of the thermoplastic resin film refers to a melting point of the entire thermoplastic resin film formed of multiple laminated layers. When the layer structure of the thermoplastic resin film is a multilayer structure, the melting point is measured by the method for measuring the melting point of thermoplastic resin films described above. If multiple endothermic peaks are observed during the second increase in temperature, the lowest melting point is determined to be the melting point. It is sufficient if the melting point is within 60 to 120° C.

When the layer structure of the thermoplastic resin film is a multilayer structure, the melting point of each layer is not particularly limited. However, when the thermoplastic resin film is used for packaging a hot-melt adhesive, the melting point of the outermost layer laminated on the side opposite the surface that comes in contact with the hot-melt adhesive is preferably 90° C. or more. This configuration further suppresses blocking. The melting point of layers other than the outermost layer is preferably less than 90° C. This configuration enables the thermoplastic resin film according to the present invention to melt faster.

When the layer structure of the thermoplastic resin film is a multilayer structure, the elastic modulus in a TD direction and the elastic modulus in an MD direction of the thermoplastic resin film refer to the elastic modulus of the entire thermoplastic resin film formed of multiple laminated layers. It is sufficient if each elastic modulus is 15 MPa.

The thickness of the thermoplastic film is not particularly limited, and is preferably 10 to 230 μm, more preferably 15 to 210 μm, and further preferably 20 to 190 μm.

Since the thermoplastic resin film according to the present invention has the above-described configuration, the thermoplastic resin film can be suitably used for packaging hot-melt adhesives.

2. Meltable Bag

The meltable bag according to the present invention is a meltable bag formed of the above thermoplastic resin film.

The size of the meltable bag is not particularly limited, and may be appropriately determined in accordance with the volume of a hot-melt adhesive to be packaged. For example, when the meltable bag has a rectangular shape, the length of the meltable bag in a long-side direction is preferably 5.0 to 40 cm and more preferably 10 to 35 cm. The length of the meltable bag in a short-side direction is preferably 2.0 to 30 cm and more preferably 5.0 to 25 cm.

The method for forming a meltable bag using a thermoplastic resin film is not particularly limited. A thermoplastic resin film may be formed in a bag-like shape by a publicly known method. Such a method is, for example, a method in which two thermoplastic resin films are placed one over another, and the end portions are heat-sealed. The heat-sealing width is not particularly limited, and is preferably 1 to 10 mm and more preferably 2 to 8 mm.

3. Packaged Hot-Melt Adhesive

The packaged hot-melt adhesive according to the present invention is a packaged hot-melt adhesive including the above meltable bag and a hot-melt adhesive packaged with the meltable bag.

The hot-melt adhesive is not particularly limited, and a publicly known hot-melt adhesive can be used. Such a hot-melt adhesive is, for example, a hot-melt adhesive that contains a resin used for hot-melt adhesives, such as a styrene block copolymer, and that optionally contains a tackifying resin, a plasticizer, or the like. The outside of the hot-melt adhesive may be coated with a non-adhesive layer.

The shape of the hot-melt adhesive is not particularly limited, and may be a publicly known shape as a hot-melt adhesive, such as a pillow shape. The above meltable bag may include a plurality of hot-melt adhesives.

The packaged hot-melt adhesive according to the present invention can be produced by, for example, inserting a hot-melt adhesive through an opening of the meltable bag that has been formed in a bag-like shape whose three sides are heat-sealed so as to have the opening and then heat-sealing the opening.

Since the packaged hot-melt adhesive according to the present invention has the above configuration, the packaged hot-melt adhesive according to the present invention can be used as an adhesive by melting the whole packaged hot-melt adhesive without taking out the hot-melt adhesive from the meltable bag.

### EXAMPLES

Hereafter, Examples of the present invention will be described. The present invention is not limited to the Examples.

Raw materials used in Examples and Comparative Examples are as follows.

Polyethylene Resin (PE)

Product name “Novatec LJ802” manufactured by Japan Polyethylene Corporation (density 0.918, MFR 22)

Ethylene-Vinyl Acetate Copolymer Resin (EVA)

Product name “V406” manufactured by DUPONT-MITSUI POLYCHEMICALS Co., Ltd. (density 0.940, vinyl acetate content 20%, MFR 20)

Mixed Resin of Polyethylene Resin and Ethylene-Vinyl Acetate Copolymer Resin (PE/EVA)

Mixing PE and EVA at 85:15 (mass ratio)

Ethylene-Methyl Methacrylate Copolymer (EMMA)

Product name “AcryftWH401” manufactured by Sumitomo Chemical Co., Ltd., (density 0.940, MMA content 20%, MFR 20)

(Production of Thermoplastic Resin Film)

The above raw materials were charged into a mixing kneader equipped with a heater in an amount shown in Table 1 and kneaded while being heated at 140° C. to prepare a resin for forming a thermoplastic resin film. The resulting resin was formed into a film with a T-die film forming machine. Herein, the extrusion rate was controlled to produce a thermoplastic resin film having a thickness of 35 μm. In Examples, the thermoplastic resin film was passed through an embossing roller to emboss one surface in a pattern shown in Table 1. In Comparative Examples, embossing was not performed. In Example 5, Example 9, and Comparative Example 2, a polyethylene resin layer, an ethylene-vinyl acetate copolymer resin layer, and a polyethylene resin layer were stacked in this order.

(Formation of Meltable Bag and Packaged Hot-Melt Adhesive)

The thermoplastic resin film in each of Examples and Comparative Examples was cut into a rectangular shape with a size of 35 cm×70 cm. The end portions on the three sides were heat-sealed to form a meltable bag. The meltable bag was formed so that the embossed surface of the thermoplastic resin film corresponded to the outer surface of the meltable bag. Two kilograms of a pillow-shaped yellow hot-melt adhesive whose outside was coated with a non-adhesive layer was prepared and inserted through the opening of the meltable bag. The opening was heat-sealed at 110° C. to produce a packaged hot-melt adhesive.

Some measurements were performed by the following methods using the thermoplastic resin film and the packaged hot-melt adhesive produced as described above.

<Rzjis: Ten Point Height of Irregularities>

The ten point height of irregularities Rzjis of the embossed surface of the thermoplastic resin film was measured with a digital microscope (VHX-6000 manufactured by KEYENCE Corporation). The ten point height of irregularities Rzjis of the embossed pattern was a ten point height of irregularities Rzjis measured by a method conforming to JIS B0601:2001. The ten point height of irregularities Rzjis was calculated at two positions in each orthogonal direction on the observation surface, and the average of the four ten point heights of irregularities Rzjis in total was defined as Rzjis of the thermoplastic resin film. The ten point height of irregularities Rzjis was measured on a surface of the thermoplastic resin film which was embossed and at which protrusions of the embossed pattern were formed.

<Spc: Arithmetic Mean Peak Curvature>

By a method conforming to ISO 25178, the embossed surface of the thermoplastic resin film was captured at a magnification of 1000 times using a 3D laser scanning confocal microscope (VK-X1000) manufactured by KEYENCE Corporation and analyzed to determine an arithmetic mean peak curvature Spc.

<Sa: Arithmetic Mean Height>

By a method conforming to ISO 25178, the embossed surface of the thermoplastic resin film was captured at a magnification of 1000 times using a 3D laser scanning confocal microscope (VK-X1000) manufactured by KEYENCE Corporation and analyzed to determine an arithmetic mean height Sa.

<Sdr: Developed Interfacial Area Ratio>

By a method conforming to ISO 25178, the embossed surface of the thermoplastic resin film was captured at a magnification of 1000 times using a 3D laser scanning confocal microscope (VK-X1000) manufactured by KEYENCE Corporation and analyzed to determine a developed interfacial area ratio Sdr.

<Sz: Maximum Height>

By a method conforming to ISO 25178, the embossed surface of the thermoplastic resin film was captured at a magnification of 1000 times using a 3D laser scanning confocal microscope (VK-X1000) manufactured by KEYENCE Corporation and analyzed to determine a maximum height Sz.

<Elastic Modulus>

The thermoplastic resin film was cut into strip specimens having a width of 20 mm and a length of 100 mm. The end portion of the specimen in a long-side direction (the side in a short-side direction) was fixed to a tensile tester, and a tensile test was performed at a tension rate of 50 mm/min to measure an elastic modulus. In the case where the elastic modulus of the thermoplastic resin film in an MD direction was measured, the specimen was prepared so that the long-side direction of the specimen corresponded to an MD direction. In the case where the elastic modulus in a TD direction was measured, the specimen was prepared so that the long-side direction of the specimen corresponded to a TD direction.

<Melting Point>

The melting point of the thermoplastic resin film was measured using a differential scanning calorimeter (DSC) by a method conforming to JIS K7121. That is, the temperature was increased from room temperature to 150° C. at a rate of 10° C./min, decreased to 0° C. at a rate of 10° C./min, and then increased to 150° C. at a rate of 10° C./min. The melting point was determined from an endothermic peak observed during the second increase in temperature.

<Heat of Fusion>

The heat of fusion was determined from an endothermic peak measured by the same method as that for the measurement of the melting point.

<Haze>

The haze of the thermoplastic resin film was measured by a method conforming to JIS K7105 using a haze meter. In the embossed thermoplastic resin film, the haze was measured from a surface which was embossed and at which protrusions of the embossed pattern were formed.

<Coefficient of Friction>

The coefficient of friction of the thermoplastic resin film was measured by a method conforming to JIS K7125. In the embossed thermoplastic resin film, the coefficient of friction was measured on a surface which was embossed and at which protrusions of the embossed pattern were formed.

<Bag Breakage Resistance>

Twenty kilograms of the packaged hot-melt adhesive produced as described above was inserted into a corrugated cardboard box. The packaged hot-melt adhesive was left to stand at temperatures of 50° C., 55° C., and 65° C. for 3 days and left to stand overnight to room temperature. Subsequently, a hook for corrugated cardboard adhesion test (DF-60 manufactured by Imada Co., Ltd.) was attached to a push pull scale (FB-300N manufactured by Imada Co., Ltd.) and the hook was inserted into a lower portion of the long side of the bag. The maximum strength measured when the hook was pulled up was defined as a peel strength. Furthermore, packaging bags were pulled apart by hand, and the degree of blocking was evaluated on the basis of the following evaluation criteria to evaluate the anti-blocking properties. An evaluation result of C or higher can be regarded as being not problematic in practical use.

A: Meltable bags of packaged hot-melt adhesives are not subjected to blocking and can be easily separated from each other.

B: Meltable bags of packaged hot-melt adhesives are slightly subjected to blocking, but there is no difficulty in separating the meltable bags.

C: Meltable bags of packaged hot-melt adhesives are partly subjected to blocking, but are not broken when separated from each other.

D: Meltable bags of packaged hot-melt adhesives are subjected to blocking and broken when separated from each other.

<Internal Visibility>

The packaged hot-melt adhesive was visually observed from the outside, and the visibility of the hot-melt adhesive inside the bag was evaluated on the basis of the following criteria. The evaluation was performed by ten raters. An evaluation result of C or higher can be regarded as being not problematic in practical use.

A: All of the ten raters can visually recognize the yellow of the hot-melt adhesive inside the bag.

B: Six to nine raters out of the ten raters can visually recognize the yellow of the hot-melt adhesive inside the bag.

C: Three to five raters out of the ten raters can recognize the yellow of the hot-melt adhesive inside the bag.

D: Eight or more raters out of the ten raters cannot visually recognize the yellow of the hot-melt adhesive inside the bag.

<Melting Rate>

Four kilograms of the packaged hot-melt adhesive was charged into a 10 L applicator tank whose temperature was set to 150° C., and melted. Then, 2 kg of an additional packaged hot-melt adhesive was charged therein and melted. The melting time from the additional charge of 2 kg of the packaged hot-melt adhesive to the complete melting of the whole additional packaged hot-melt adhesive was measured to evaluate the melting rate.

Table 1 shows the results.

TABLE 1

| | | Example 1 | Example 2 | Example 3 | Example 4 | Example 5 | Example 6 | Example 7 |
|---|---|---|---|---|---|---|---|---|
| Thermoplastic resin film | | Embossed | Embossed | Embossed | Embossed | Embossed | Embossed | Embossed |
| | | film 1 | film 2 | film 3 | film 4 | film 5 | film 6 | film 7 |
| Raw material | | PE | PE | PE | PE | PE | PE/EVA | EVA |
| | | | | | | EVA | | |
| | | | | | | PE | | |
| Number of layers | | 1 | 1 | 1 | 1 | 3 | 1 | 1 |
| Rzjis: Ten point height of irregularities (μm) | | 90 | 15 | 28 | 50 | 32 | 140 | 140 |
| Spc: Arithmetic mean peak curvature (mm⁻¹) | | 2997 | 3379 | 272 | 393 | 290 | 2950 | 2980 |
| Sa: Arithmetic mean height (μm) | | 1.23 | 0.79 | 0.16 | 0.04 | 0.15 | 1.22 | 1.22 |
| Sdr: Developed interfacial area ratio | | 0.2285 | 0.2238 | 0.0019 | 0.0026 | 0.0020 | 0.2280 | 0.2278 |
| Sz: Maximum height (μm) | | 15.06 | 7.87 | 2.15 | 0.97 | 0.22 | 15.10 | 15.20 |
| Embossed pattern | | lattice | crepe | random | cloth | random | lattice | lattice |
| | | | | embossing | texture | embossing | | |
| Elastic modulus (Mpa) | MD direction | 58 | 102 | 85 | 56 | 45 | 33 | 24 |
| | TD direction | 44 | 100 | 94 | 56 | 46 | 20 | 17 |

| Melting point (° C.) | | | 107 | 107 | 107 | 107 | 83 | 83 | 83 |
|---|---|---|---|---|---|---|---|---|---|
| Heat of fusion (J/g) | | | −98 | −98 | −98 | −98 | −72 | −38 | −25 |
| Haze (%) | | | 50 | 86 | 30 | 36 | 43 | 72 | 73 |
| Coefficient of friction | | | 0.45 | 0.12 | 0.42 | 0.58 | 0.63 | 0.30 | 0.40 |
| Bag | Anti-blocking | 50° C. | A | A | A | A | A | A | A |
| breakage | properties | 55° C. | A | A | A | A | A | A | B |
| resistance | | 65° C. | B | B | B | B | B | B | C |
| | Peel strength (N) | 50° C. | 19 | 24 | 23 | 21 | 20 | 30 | 35 |
| | | 55° C. | 34 | 32 | 30 | 35 | 38 | 43 | 52 |
| | | 65° C. | 100 | 110 | 120 | 120 | 110 | 170 | 190 |

| | | | | | | | |
|---|---|---|---|---|---|---|---|
| Internal visibility | B | C | A | A | A | B | B |
| Melting rate (min) | 60 | 60 | 60 | 60 | 50 | 50 | 40 |

| | | | | | Comparative | Comparative |
|---|---|---|---|---|---|---|
| | | Example 8 | Example 9 | Example 10 | Example 1 | Example 2 |
| Thermoplastic resin film | | Embossed | Embossed | Embossed | Plain film 1 | Plain film 2 |
| | | film 8 | film 9 | film 10 | | |
| Raw material | | EVA | PE | EMMA | PE | PE |
| | | | EMMA | | | EVA |
| | | | PE | | | PE |
| Number of layers | | 1 | 3 | 1 | 1 | 3 |
| Rzjis: Ten point height of irregularities (μm) | | 10 | 31 | 33 | 2 | 6 |
| Spc: Arithmetic mean peak curvature (mm⁻¹) | | 3400 | 273 | 280 | 160 | 170 |
| Sa: Arithmetic mean height (μm) | | 0.80 | 0.15 | 0.16 | 0.03 | 0.03 |
| Sdr: Developed interfacial area ratio | | 0.2236 | 0.0020 | 0.0020 | 0.0006 | 0.0005 |
| Sz: Maximum height (μm) | | 7.80 | 1.00 | 1.20 | 0.57 | 0.56 |
| Embossed pattern | | crepe | random | random | — | — |
| | | | embossing | embossing | | |
| Elastic modulus (Mpa) | MD direction | 35 | 50 | 23 | 143 | 70 |
| | TD direction | 36 | 54 | 20 | 173 | 90 |

| Melting point (° C.) | | | 83 | 75 | 75 | 107 | 84 |
|---|---|---|---|---|---|---|---|
| Heat of fusion (J/g) | | | −25 | −60 | −20 | −98 | −72 |
| Haze (%) | | | 86 | 31 | 33 | 5 | 6 |
| Coefficient of friction | | | 0.11 | 0.47 | 0.20 | 0.10 | 0.10 |
| Bag | Anti-blocking | 50° C. | A | A | A | B | B |
| breakage | properties | 55° C. | B | A | B | C | C |
| resistance | | 65° C. | C | B | C | D | D |
| | Peel strength (N) | 50° C. | 33 | 21 | 45 | 80 | 82 |
| | | 55° C. | 51 | 38 | 61 | 99 | 103 |
| | | 65° C. | 200 | 110 | 230 | 270 | 280 |

| | | | | | |
|---|---|---|---|---|---|
| Internal visibility | C | A | A | A | A |
| Melting rate (min) | 40 | 50 | 40 | 90 | 60 |

1. A thermoplastic resin film comprising at least one resin selected from the group consisting of a polyethylene resin and an ethylene-based copolymer, wherein
(1) the film has at least one embossed surface, and the at least one embossed surface has a ten point height of irregularities Rzjis of 10 to 200 μm,
(2) the film has a melting point of 60° C. to 120° C., and
(3) an elastic modulus in a TD direction and an elastic modulus in an MD direction are both 15 MPa or more.

2. The thermoplastic resin film according to claim 1, wherein the ethylene-based copolymer includes ethylene-vinyl ester copolymers and/or ethylene(meth)acrylic acid ester copolymers.

3. The thermoplastic resin film according to claim 1, wherein the film has a melting point of 70 to 120° C., and the ethylene-based copolymer is an ethylene-vinyl acetate copolymer.

4. The thermoplastic resin film according to claim 1, wherein the ethylene-based copolymer is at least one member selected from the group consisting of ethylene-vinyl acetate copolymers, ethylene-methyl acrylate copolymers, ethylene-methyl methacrylate copolymers, ethylene-ethyl acrylate copolymers, ethylene-butyl acrylate copolymers, ethylene-octyl acrylate copolymers, ethylene-2-ethylhexyl acrylate copolymers, ethylene-ethyl methacrylate copolymers, ethylene-butyl methacrylate copolymers, ethylene-octyl methacrylate copolymers, and ethylene-2-ethylhexyl methacrylate copolymers.

5. The thermoplastic resin film of claim 1, wherein the at least one embossed surface has an arithmetic mean peak curvature Spc of less than 4000 mm⁻¹ as measured in conformity with ISO 25178.

6. The thermoplastic resin film of claim 1, for packaging a hot-melt adhesive.

7. A meltable bag comprising the thermoplastic resin film of claim 1.

8. A packaged hot-melt adhesive comprising the meltable bag according to claim 7 and a hot-melt adhesive packaged with the meltable bag.
